(19) United States
(12) Patent Application Publication
(10) Pub. No.: US 2003/0076157 A1
(43) Pub. Date: Apr. 24, 2003

(54) Circuit of bias-current sourcec with a band-gap design

(76) Inventor: Tzi-Hsiung Shu, San Jose, CA (US)

Correspondence Address: J.C. Patents, Inc., Suite 114, 1340 Reynolds Ave., Irvine, CA, 92614, US

(21) Appl. No.: 09/838,401

(22) Filed: Apr. 19, 2001

Related U.S. Application Data
(60) Provisional application No. 60/209,892, filed on Jun. 6, 2000.

(51) Int. Cl. G05F 1/10

(52) U.S. Cl. 327/538

(57) ABSTRACT

A circuit of bias-current source has a band-gape designed circuit associating with a V-I converter. The band-gap circuit has a first output node A. From the first node A to a ground, a first resistor, a second resistor and a diode are connected in cascade. A second output node B is referred to the junction between the first and the second resistors. The first node A and second node B supply a first voltage source and a second voltage source, respectively. The second voltage is voltage source and the first voltage source is converted into a current source by a V-I converter that has an operational amplifier (op-amp), a third resistor, a first transistor, and a second transistor. A Negative input end of the op-amp receives the first voltage, and a positive input end of the op-amp receives a feedback. An output from the operational amplifier is coupled to gate of the first transistor. A source of the first transistor is applied with a system voltage. A drain of the first transistor is fed back to the op-amp and coupled to the third resistor. The third resistor is grounded at the other end. The second MOS transistor is coupled in parallel to the first MOS transistor, whereby a stable current source is exported from its drain to serve as a stable second current source.

### CROSS-REFERENCE TO RELATED APPLICATION

This application claims the priority benefit of U.S.A. provisional application serial No. 60/209,892, filed Jun. 6, 2000.

### BACKGROUND OF THE INVENTION

1. Field of Invention

The present invention relates to an electronic circuit. More particularly, the present invention relates to a circuit of bias-current source with band-gap circuit used as a bias-current source for various applications with low supply voltage.

2. Description of Related Art

Some semiconductor integrated circuit (IC) devices are usually driven by a stable low voltage, such as 3.3 V or less, in different designs, and a stable current source may be also needed. Currently, a conventional band-gap circuit has been designed out to serve as a bias-current source for wide applications. As well known, temperature is an essential factor and may affect the properties of electronic elements, such as diodes or resistors. For the conventional band-gap circuit, a stable voltage output can be achieved by eliminating the temperature effects by adjust the resistor so as to compensate the temperature effects from the diodes. However, if the voltage output of the conventional band-gap is converted into a current source, the current source is still unstable due to the temperature effects.

A typical band-gap circuit is shown in FIG. 1. In FIG. 1, the band-gap circuit for a referencing source is, for example, formed in a complementary MOS (metal-oxide semiconductor) manner. The band-gap circuit includes six P-type MOS transistors (PMOS) and four N-type MOS (NMOS) transistors, diodes D1, D2, D3, and resistors R1, R2. The output node A has a voltage output V_{BG}. From the output node A to the ground, the resistor R2 and the diode D3 are coupled in cascade. A current I flows from the PMOD transistor 10 to the output node A. The diodes D1, D2, and D3 are a type of base-emitter diode, which is equivalent to a transistor with a common connection on the base and the emitter as shown in the separated box.

The six PMOS transistors form three cascade PMOS pairs 10a, 10b, and 10c, working as a group. A low supply voltage Vcc to applied to each pair. The four NMOS transistors 12 also form two cascade NMOS pairs 12a and 12b. Two of the three PMOS pairs, such as the pairs 10a and 10b, are respectively coupled to the two NMOS pairs 12a and 12b in cascade. The other end of the NMOS pair 12a is coupled to the diode D1 and to the ground. The other end of the NMOS pair 12b is coupled to the resistor R2 and the diode D2 in cascade, and then to the ground. The PMOS pair 10c is coupled to the output node A, and supplies the current I for output. The typical band-gap circuit, serving as a referencing source, is well known by the one skilled in the art. The detailed design is not further described here, but the properties due to the temperature effects is following.

According to the circuit, the current satisfied the relation:

$$I = \frac{Δ {V}_{BE}}{{R}_{1}} = \frac{α}{{R}_{1}} \cdot {V}_{T} , \qquad ( 1 )$$

where ΔV_{BE} is the voltage difference across the two diodes D1 and D2, V_{T} is the thermal voltage KT/q, and α is equal to ln(m). Since all resistors in an IC device have temperature effects, each resistor Rᵢ is expressed by an equation:

Rᵢ=Rᵢ₀·(1+T_{CR}·(T−T₀)), (2)

where Rᵢ₀ is the resistance at temperature T₀, T_{CR} is the first-order temperature coefficient of the resistor Rᵢ, and T is the current temperature. Therefore, the voltage V_{BG} can be derived as:

$${V}_{BG} = {V}_{BE3} + \frac{{R}_{2}}{{R}_{1}} \cdot α \cdot {V}_{T} = {V}_{BE3} + {K}_{1} \cdot {V}_{T} , \qquad ( 3 )$$

where

$${K}_{1} = \frac{{R}_{2}}{{R}_{1}} \cdot α$$

is constant over temperature. Since V_{BE} has a negative temperature coefficient and V_{T} has a positive temperature coefficient, the temperature characteristics of the voltage V_{BG} can be designed to maintain zero temperature coefficient with proper adjustment of the value K₁.

However, as the voltage V_{BE} is converted into a current source by a typical voltage-to-current (V-I) converter, the current source is still affected by the temperature effects, causing an unstable current source. The typical V-I converter is shown in FIG. 2. In FIG. 2, an operational amplifier 14 is assumed to be ideally operated. The input voltage Vin is the V_{BE} when it is connected to the output node A of the band-gap circuit of FIG. 1. The output of the operational amplifier 14 is coupled to a gate of a NMOS transistor 16, of which the source is feed back to the operational amplifier 14 and also connected a resistor R3. The resistor R3 is grounded at the other end. The drain of the NMOS transistor 16 is coupled to an NMOS transistor 18 at its drain. Another NMOS transistor 20 is coupled in parallel to the NMOS transistor 18. The NMOS transistors 18 and 20 is applied with the system voltage Vcc. The current source I′ₒᵤₜ is obtained from the drain of the NMOS transistor 20.

For the operational amplifier 14, its current output Iₒᵤₜ satisfies the relation of

$${I}_{out} = \frac{{V}_{i n}}{{R}_{3}} . \qquad ( 4 )$$

In the above manner, even if the input voltage Vin has zero temperature coefficient, the output current is not because the resistor R₃ has its non-zero temperature coefficient. This is one main drawback for the conventional V-I converter associating with the conventional band-gap circuit.

In addition, Since the NMOS transistor 16 is used in source follower configuration, the gate voltage V gate is at least one threshold higher than the source node voltage. In the case with low voltage design, the voltage headroom may be insufficient to allow the circuit to function properly if Vin is too high. This is at least another drawback for the conventional V-I converter associating with the conventional band-gap circuit.

### SUMMARY OF THE INVENTION

The invention provides a circuit of bias-current source with a band-gap design, associating with a V-I converter, whereby a stable voltage source and a stable current source are achieved.

The circuit of bias-current source includes a band-gap designed circuit associating with a V-I converter. The band-gap designed circuit has a first output node A. From the first output node A to a system ground, a resistor and a diode are connected in cascade. The resistor includes a first resistor and a second resistor also coupled in cascade. The junction between the first resistor and the second resistor is denoted as a second output node B. The first output node A supplies a first voltage source, and the second output node B supplies a second voltage source. The second resistor is used to compensate a temperature effect, whereby the second voltage source has substantially zero temperature coefficient.

The V-I converter includes an operational amplifier, a third resistor, a first MOS transistor, and a second MOS transistor. A negative input end of the operational amplifier receives the first voltage source from the output node A, and a positive input end of the operational amplifier receives a feedback. An output from the operational amplifier is coupled to a gate of the first MOS transistor. A source of the first MOS transistor is applied with a system voltage Vcc. A drain of the first MOS transistor is fed back to the operational amplifier, and also coupled to the third resistor at one end. The other end of the third resistor is grounded, so that a first current flows through the third resistor. The second MOS transistor is also coupled to the system voltage Vcc, in parallel to the first MOS transistor, to receive the output of the operational amplifier at its gate, and export a second current from its drain to serve as a stable current source.

In the above manner, since the thirst resistor is also coupled to the positive input end of the operational amplifier, it produce a temperature effect, while the second resistor of the band-gap designed circuit produces an opposite temperature effect to compensate. As a result, the temperature effect for the current source is effectively eliminated.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a circuit drawing, illustrating a conventional band-gap circuit;

FIG. 2 is a circuit drawing, illustrating a conventional V-I converter associating with the band-gap circuit of FIG. 1.

FIG. 3 is a circuit drawing, illustrating a band-gap designed circuit, according to a preferred embodiment of the invention; and

FIG. 4 is a circuit drawing, illustrating a V-I converter associating with the band-gap designed circuit of FIG. 3, according to the preferred embodiment of the invention.

### DESCRIPTION OF THE PREFERRED EMBODIMENTS

As previously described, even though the conventional band-gap circuit has a voltage source free from the temperature effects, it is still has temperature effect when the voltage source is converted by a V-I converter. The invention provides an improved band-gap designed circuit incorporating an improved V-I converter, so that both the voltage source and the current source substantially free from temperature effect is achieved. An additional resistor at the voltage output node is added, and the improved V-I converter is accordingly used by inputting the voltage source to the negative input end of an operation amplifier while a feedback is fed back to the positive input end of the operational amplifier. The feedback carries compensating temperature effect so that the temperature effect for the current source is effectively eliminated.

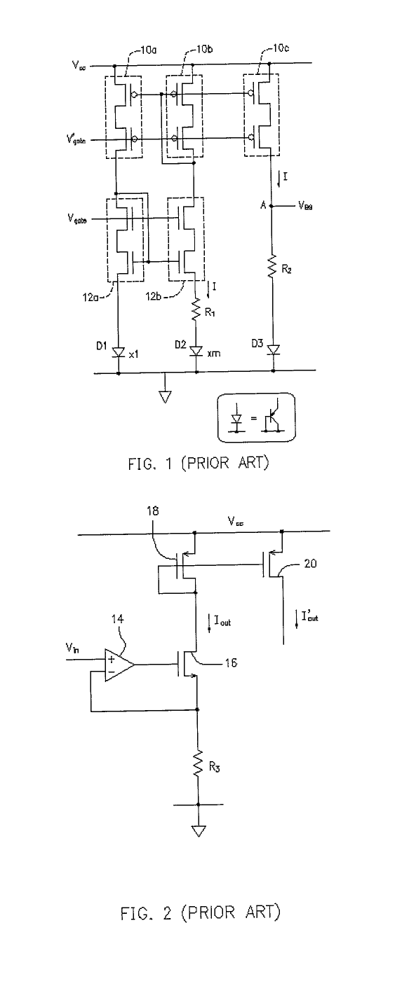

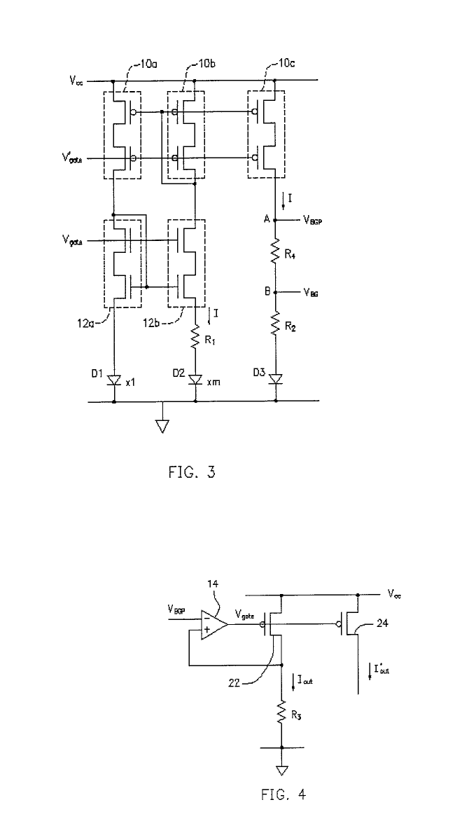

In order to maintain zero temperature coefficient in the output current Iₒᵤₜ, the input voltage should be changed to include a comparable temperature coefficient term to cancel the effect from the resistor. The conventional band-gap circuit is modified to include an additional resistor R4 coupled to the resistor R2, so as to produce a higher voltage. FIG. 3 is a circuit drawing, illustrating a band-gap designed circuit, according to a preferred embodiment of the invention. In FIG. 3, the band-gap designed circuit is similar to the conventional band-gap circuit of FIG. 1, but the additional resistor R4 is added to be coupled to the resistor R2 in series. From the voltage output node A to the system ground, the resistor R4, the resistor R2, and the diode D3 are coupled in cascade. The diodes D1, D2, and D3 preferably include a base-emitted diode. The voltage output node A provides a voltage source V_{BGP}. The junction between the resistor R4 and the resistor R2 is denoted as another voltage node B that provides a voltage source V_{BG}. By adjusting the resistors R2 and R4, the voltage source V_{BG} has substantially zero temperature coefficient. The voltage source V_{BGP} at the voltage output node A has a relation:

V_{BGP}=V_{BG}+K₂·V_{T}, (5)

where

$${K}_{2} = \frac{{R}_{4}}{{R}_{1}} \cdot α$$

is a constant. The temperature coefficient of V_{BGP} is therefore adjustable through K₂ and can be made to match that of the resistor.

Moreover, since the voltage source V_{BGP} is higher than the regular band-gap voltage V_{BG}, the conventional V-I converter of FIG. 2 may no longer function properly in low supply voltages. Also and, the temperature effect for the current source through the conventional V-I converter is still there due to having no cancellation on the temperature coefficient. In order to have a current source with substantially zero temperature coefficient, another V-I converter of the invention is shown in FIG. 4. In FIG. 4, the V-I converter of the invention includes an operational amplifier 14, a resistor R3, at least one MOS transistor, such as a PMOS transistor 22 and a PMOS transistor 24. The PMOS transistors 22, 24 are coupled in parallel, where the source ends are applied with the system voltage Vcc, and the gate is commonly coupled to an out put of the operational amplifier 14. The drain of the PMOS transistor 24 provides the intended current source without temperature effect. The drain of the PMOS transistor 22 is connected to the resistor R3 and to the ground, and is also fed back to an positive input end of the operational amplifier 14. The negative input end of the operational amplifier 14 receives the voltage source V_{BGP}.

In the configuration of the V-I converter of FIG. 4 associating with the band-gap designed circuit of FIG. 3, the current Iₒᵤₜ flowing through the resistor R3 is Iₒᵤₜ=V_{BGP}/R3. Applying equation (5) to the current Iₒᵤₜ, a relation is obtained as follows:

$${I}_{out} = \frac{{V}_{BG} + {K}_{2} \cdot {V}_{T}}{{R}_{3}} . \qquad ( 6 )$$

This allows the temperature coefficient to be effectively cancelled away. The temperature effect from resistor R3 at the denominator is cancelled by the temperature effect from the term K₂·V_{T} at the numerator. The voltage source V_{BG} has no temperature effect. As a result, the current source Iₒᵤₜ has no substantial temperature effect. The actual current source I′ₒᵤₜ is equal to the current source Iₒᵤₜ, that is, Iₒᵤₜ=I′ₒᵤₜ.

In the above design, conductive type of the MOS transistors in use can be generally replaced by a different conductive type, as well known by the one skilled in the art. For example, a P-type MOS transistor can be replaced by an N-type MOS transistor, according to the design, without failure to achieve the same function.

In summary, the circuit of bias-current circuit with a band-gap design, according to the invention, provides a voltage source without temperature effect as the circuit is operated at low supply voltage. The circuit also provides a current source has no temperature effect as the voltage source id converted by a V-I converter. The V-I converter includes a resistor, which associates with the operational amplifier 14, so that produces a cancellation on the temperature effect.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A circuit bias-current source with band-gap design under operation with a system voltage Vcc, the circuit comprising:
a band-gap designed circuit comprising a first resistor, a second resistor, and a diode coupled in cascade from a first voltage output node A to a system ground, wherein a junction between the first resistor and the second resistor is denoted as a second voltage output node B, and the first voltage output node A and the second voltage output node B supply a first voltage source and a second voltage source, respectively; and
a voltage-to-current (V-I) converter having an operational amplifier (op-amp), a third resistor, a first metal-oxide semiconductor (MOS) transistor, and a second MOS transistor if a current source is intended, wherein a negative input end of the op-amp receives the first voltage source from the band-gap designed circuit, a positive input end of the op-amp receives a feedback,
an output from the op-amp is coupled to a gate of the first MOS transistor, a source of the first MOS transistor is applied with the system voltage Vcc, a drain of the first MOS transistor is fed back to the op-amp at the positive input end and also coupled to the third resistor at one end of the third resistor while another end is grounded, and
the second MOS transistor is also coupled to the system voltage Vcc, in parallel to the first MOS transistor, to receive the output of the op-amp at its a gate and export a current from its a drain to serve as the current source.

2. The circuit of claim 1, wherein the diode comprises a base-emitted diode.

3. The circuit of claim 1, wherein the first, second, and, the third MOS transistors are P-type MOS transistors.

4. The circuit of claim 1, wherein the first, second, and, the third MOS transistors are N-type MOS transistors.

5. The circuit of claim 1, wherein the system voltage is about 3.3 volts or less.

6. The circuit of claim 1, wherein the second voltage source has substantially zero temperature coefficient by properly including a compensation effect from the second resistor and the second resistor of the band-gap designed circuit.

7. The circuit of claim 1, wherein a temperature effect from the first resistor of the band-gap designed circuit is compensated by a temperature effect of the third resistor of the V-I converter.

8. A method for generating a voltage source and a current source in a band-gap design under operation with a system voltage Vcc, the method comprising:
providing a band-gap designed circuit, comprising a first resistor, a second resistor, and a diode coupled in cascade from a first voltage output node A to a system ground, wherein a second voltage output node B takes from a junction between the first resistor and the second resistor, and the first voltage output node A and the second voltage output node B supply a first voltage source and a second voltage source, respectively;
adjusting the first resistor and the second resistor to have a substantially zero temperature effects for the second voltage source;
providing an voltage-to-current (V-I) converter to convert the first voltage source into a current source if the current source is intended, wherein the V-I converter comprises an operational amplifier;
inputting the first voltage source of the band-gap designed circuit to a negative end of the operational amplifier while a positive input end of the operational amplifier receives a feedback;
exporting an output of the operational amplifier to at least one metal-oxide semi-conductor (MOS) transistor at a gate;
feeding an output from a drain of the at lest one MOS transistor back to the positive input end of the operational amplifier, and also connecting the drain of the at lest one MOS transistor to a third resistor and then to the system ground; and
adjusting the third resistor to substantially eliminate temperature effect carried by the first voltage source.

9. The method of claim 8, wherein the at least one MOS transistor comprises two MOS transistors in parallel, in which one of the two MOS transistor without connection to the third resistor provides the current source.

10. The method of claim 8, wherein the at least one MOS transistor comprises P-type MOS transistors.
